(19) United States
(12) Patent Application Publication
(10) Pub. No.: US 2017/0130091 A1
(43) Pub. Date: May 11, 2017

(54) AUTOMOTIVE PARTS AND PROCESSES FOR PRODUCING THE SAME

(71) Applicants: DAICEL CORPORATION, Osaka (JP); TOYOTA JIDOSHA KABUSHIKI KAISHA, Toyota-shi (JP)

(72) Inventors: Yutaka ISOBE, Himeji-shi (JP); Ippei FUKUTOMI, Toyota-shi (JP); Naoya IKEDA, Toyota-shi (JP); Kazuyoshi MANABE, Toyota-shi (JP)

(73) Assignees: DAICEL CORPORATION, Osaka (JP); TOYOTA JIDOSHA KABUSHIKI KAISHA, Toyota-shi (JP)

(21) Appl. No.: 15/298,852

(22) Filed: Oct. 20, 2016

(30) Foreign Application Priority Data
Nov. 10, 2015 (JP) 2015-220435

(51) Int. Cl. C09D 163/00; C09J 163/00; B05D 1/28; B05D 1/02; B05D 1/00; C09D 177/00; C09J 177/00

(52) U.S. Cl. CPC C09D 163/00; C09D 177/00; C09J 163/00; C09J 177/00; B05D 1/02; B05D 1/005; B05D 1/28

(57) ABSTRACT

An automotive part comprises a substrate and a heat-resistant layer. The heat-resistant layer contains a first layer on a surface of the substrate and a second layer on the first layer. The first layer contains a polyamideimide resin. The second layer contains a cured product of (A) a curable liquid composition containing an alicyclic epoxy compound represented by the formula (1):

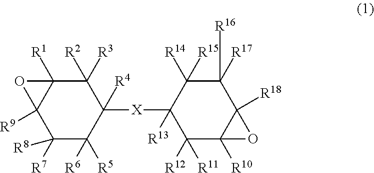

wherein R¹ to R¹⁸ are the same or different and each represent a hydrogen atom, a halogen atom, an oxo group, a hydroxyl group, a hydroperoxy group, an amino group, a sulfo group, or an organic group, and X represents a direct bond or a linkage group.

### TECHNICAL FIELD

The present invention relates to automotive parts having sliding properties, heat resistance, or other characteristics and processes for producing the same.

### BACKGROUND ART

Highly adhesive epoxy resins are used as coating agents for surface-treating various molded products such as automotive parts. Japanese Patent Application Laid-Open Publication No. 7-189804 (JP-7-189804A, Patent Document 1) discloses an internal-combustion piston having an abrasion-resistant first coating layer and a second coating layer formed thereon. The first coating layer contains a polyamideimide or a polyimide and a solid lubricant, and the second coating layer formed of an epoxy resin having a hardness lower than that of the first coating layer. According to this document, the first coating layer is formed of a polyamideimide or a polyimide in order to achieve an excellent initial conformability and impart an improved abrasion resistance to a conventional epoxy-resin-based monolayer coating containing a fluorocarbon resin.

This document, however, fails to describe details of the epoxy resin. Widely used epoxy resins have low sliding properties or rigidity (or hardness).

Japanese Patent Application Laid-Open Publication No. 2008-189853 (JP-2008-189853A, Patent Document 2) discloses a photo-curable resin composition which contains combination of an alicyclic diepoxy compound containing 3,4,3′,4′-diepoxybicyclohexyl compound and at least one compound selected from the group consisting of an epoxy compound other than the alicyclic diepoxy compound, an oxetane compound, a vinyl ether compound, an acrylic polymer, and a di- to hexa-hydric polyol compound. The photo-curable composition is suitable for use as a coating agent, e.g., an automotive clear paint, a top coating agent for a plastic film, a protective coating agent for a plastic part, and a coating agent for forming a color filter overcoating.

Unfortunately, a coating film formed from the composition has a low heat resistance and is insufficient in sliding properties or rigidity.

Japanese Patent Application Laid-Open Publication No. 2014-191173 (JP-2014-191173A, Patent Document 3) discloses a hard coat film having a plastic substrate and a hard coat layer formed on at least one surface of the plastic substrate. The hard coat layer is formed from a curable composition containing 3,4,3′,4′-diepoxybicyclohexyl, a hydroxyl-containing silicone compound and/or a silica filler, and an acid generator.

The hard coat layer presupposes that the layer is formed on the surface of the plastic substrate. The document has no intention of improving heat resistance.

In particular, compared with an epoxy resin such as a bisphenol A-based epoxy compound which is utilized as a widely used adhesive, the alicyclic epoxy compound usually has excellent sliding properties or rigidity while the alicyclic epoxy compound has a low adhesiveness or adhesion. The sliding properties and the adhesion are conflicting characteristics and as such, are incompatible.

### CITATION LIST

### Patent Literature

Patent Document 1: JP-7-189804A (claim 1, paragraphs [0002] and [0003], and Table 1)

Patent Document 2: JP-2008-189853A (claim 1, paragraph [0014], and Examples)

Patent Document 3: JP-2014-191173A (claim 1)

### SUMMARY OF INVENTION

### Technical Problem

It is therefore an object of the present invention to provide a part having excellent sliding properties and heat resistance and a process for producing the part.

Another object of the present invention is to provide an automotive part having an automotive substrate (or a substrate for an automobile) and a heat-resistant layer which is easily formed on the substrate by coating and has a high rigidity and a high adhesion strength, and a process for producing the automotive part.

### Solution to Problem

The inventors of the present invention made intensive studies to achieve the above objects and finally found that formation of a first layer containing a polyamideimide resin on a surface of an automotive substrate and formation of a second layer containing a cured product of a curable liquid composition containing a specific alicyclic epoxy compound on the first layer enables the surface of the automotive substrate to have sliding properties and heat resistance. The present invention was accomplished based on the above findings.

That is, an aspect of the present invention provides an automotive part containing a substrate and a heat-resistant layer having a first layer on a surface of the substrate and a second layer on the first layer. The first layer contains a polyamideimide resin, and the second layer contains a cured product of (A) a curable liquid composition containing an alicyclic epoxy compound represented by the formula (1):

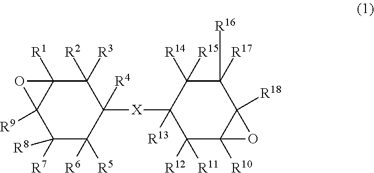

wherein R¹ to R¹⁸ are the same or different and each represent a hydrogen atom, a halogen atom, an oxo group, a hydroxyl group, a hydroperoxy group, an amino group, a sulfo group, or an organic group, and X represents a direct bond or a linkage group.

The curable liquid composition (A) may further contain a curing agent and/or a leveling agent. The first layer may further contain at least one solid lubricant selected from the group consisting of a fluorine compound, a metal sulfide, and a carbon material. In the above formula (1), at least one of R¹ to R¹⁸ may be a hydrogen atom, and X may be a direct bond.

The second layer may have an indentation hardness of not less than 300 N/mm² measured by a microhardness tester. The average thickness of the second layer may be about 2 to 100 times as large as that of the first layer. The substrate may be formed of a metal. The metal may be aluminum or an alloy thereof. The automotive part may be produced by a process which comprises the steps of: applying (B) a liquid composition containing a polyamideimide resin on a surface of a substrate and solidifying the applied liquid composition (B) to form a first layer, and applying the curable liquid composition (A) on a surface of the resulting first layer and curing the applied liquid composition (A) to form a second layer.

### Advantageous Effects of Invention

The surface of the automotive substrate has the first layer containing the polyamideimide resin and the second layer on the first layer, and the second layer contains the cured product of the curable liquid composition containing the specific alicyclic epoxy compound. This allows sliding properties and heat resistance to be imparted to the surface of the automotive substrate. Further, combination of the alicyclic epoxy compound, which has low adhesion, with the polyamideimide resin allows formation of a highly rigid heat-resistant layer on a surface of a molded product at a high adhesion strength by coating.

### BRIEF DESCRIPTION OF DRAWINGS

FIG. 1 is a schematic view of an example of a cam nose portion having a heat-resistant layer.

FIG. 2 is a cross-sectional view taken along line II-II in FIG. 1.

FIG. 3 is a schematic view of an example of a piston skirt portion having a heat-resistant layer.

FIG. 4 is a cross-sectional view taken along line IV-IV in FIG. 3.

FIG. 5A is a schematic view of an example of a roller rocker portion having a heat-resistant layer.

FIG. 5B is a side view of FIG. 5A.

FIG. 6A is a schematic view of an example of a chain damper portion having a heat-resistant layer.

FIG. 6B is a partial cross-sectional view of FIG. 6A.

FIG. 7 is a schematic view of an example of a valve lifter portion having a heat-resistant layer.

FIG. 8 is a schematic view of an example of a cam and crank bearing portion having a heat-resistant layer.

### DESCRIPTION OF EMBODIMENTS

[Automotive Part]

An automotive part according to an embodiment of the present invention includes a substrate and a heat-resistant layer (a low-friction layer). The heat-resistant layer contains a first layer (a primer layer) disposed on a surface of the substrate and a second layer (a topcoat layer) disposed on the first layer.

(A) Second Layer

The second layer contains a curable liquid composition (A) containing the above-described alicyclic epoxy compound.

(Alicyclic Epoxy Compound)

The alicyclic epoxy compound is represented by the formula (1) described above. In R¹ to R¹⁸ of the above formula (1), the halogen atom may include, for example, fluorine atom, chlorine atom, bromine atom, and iodine atom.

The organic group may include, but should not be limited to, a carbon-containing group, for example, a hydrocarbon group, an alkoxy group, an alkenyloxy group, an aryloxy group, an aralkyloxy group, an acyl group, an acyloxy group, an alkylthio group, an alkenylthio group, an arylthio group, an aralkylthio group, a carboxyl group, an alkoxycarbonyl group, an aryloxycarbonyl group, an aralkyloxycarbonyl group, an epoxy group, an epoxy-containing group, an oxetanyl group, an oxetanyl-containing group, a cyano group, an isocyanate group, a carbamoyl group, an isothiocyanate group, and a substituted amino group.

As examples of the hydrocarbon group, there may be mentioned an aliphatic hydrocarbon group, an alicyclic hydrocarbon group, and an aromatic hydrocarbon group.

The aliphatic hydrocarbon group may include, for example, an alkyl group, an alkenyl group, and an alkynyl group. As examples of the alkyl group, there may be mentioned a C₁₋₂₀alkyl group such as methyl group, ethyl group, propyl group, isopropyl group, butyl group, hexyl group, octyl group, isooctyl group, decyl group, or dodecyl group (preferably a C₁₋₁₀alkyl group, more preferably a C₁₋₄alkyl group). The alkenyl group may include, for example, a C₂₋₂₀alkenyl group such as vinyl group, allyl group, methallyl group, 1-propenyl group, isopropenyl group, butenyl group, pentenyl group, or hexenyl group (preferably a C₂₋₁₀alkenyl group, more preferably a C₂₋₄alkenyl group). As examples of the alkynyl group, there may be mentioned a C₂₋₂₀alkynyl group such as ethynyl group or propynyl group (preferably a C₂₋₁₀alkynyl group, more preferably a C₂₋₄alkynyl group).

The alicyclic hydrocarbon group may include, for example, a C₃₋₁₂cycloalkyl group such as cyclopropyl group, cyclobutyl group, cyclopentyl group, cyclohexyl group, or cyclododecyl group (in particular, a C₅₋₈cycloalkyl group); a C₃₋₁₂cycloalkenyl group such as cyclohexenyl group; and a C₄₋₁₅crosslinked cyclic hydrocarbon group such as bicycloheptanyl group or bicycloheptenyl group.

As examples of the aromatic hydrocarbon group, there may be mentioned a C₆₋₁₄aryl group such as phenyl group or naphthyl group (in particular, a C₆₋₁₀aryl group).

The alkoxy group may include a C₁₋₁₀alkoxy group such as methoxy group, ethoxy group, propoxy group, isopropyloxy group, butoxy group, or isobutyloxy group (preferably a C₁₋₆ alkoxy group, more preferably a C₁₋₄alkoxy group). As examples of the alkenyloxy group, there may be mentioned a C₂₋₁₀alkenyloxy group such as allyloxy group (preferably a C₂₋₆alkenyloxy group, more preferably a C₂₋₄alkenyloxy group). The aryloxy group may include, for example, a C₆₋₂₀aryloxy group such as phenoxy group, tolyloxy group, or naphthyloxy group (in particular, a C₆₋₁₄aryloxy group). As examples of the aralkyloxy group, there may be mentioned a C₇₋₂₀aralkyloxy group such as benzyloxy group or phenethyloxy group (in particular, a C₇₋₁₈aralkyloxy group).

Examples of the acyl group may include a C₁₋₂₀acyl group such as acetyl group, propionyl group, (meth)acryloyl group, or benzoyl group (in particular, a C₁₋₁₂acyl group). As examples of the acyloxy group, there may be mentioned a C₁₋₂₀acyloxy group such as acetyloxy group, propionyloxy group, (meth)acryloyloxy group, or benzoyloxy group (in particular, a C₁₋₁₂acyloxy group).

The alkylthio group may include, for example, a C₁₋₆ alkylthio group such as methylthio group or ethylthio group (in particular, a C₁₋₄alkylthio group). As examples of the alkenylthio group, there may be mentioned a C₂₋₆alkenylthio group such as allylthio group (in particular, a C₂₋₄alkenylthio group). The arylthio group may include, for example, a 6-20arylthio group such as phenylthio group, tolylthio group, or naphthylthio group (in particular, a C₆₋₁₄arylthio group). Examples of the aralkylthio group may include a C₆₋₂₀aralkylthio group such as benzylthio group or phenethylthio group (in particular, a C₇₋₁₈ aralkylthio group).

The alkoxycarbonyl group may include, for example, a C₁₋₁₀ alkoxy-carbonyl group such as methoxycarbonyl group, ethoxycarbonyl group, propoxycarbonyl group, or butoxycarbonyl group (in particular, a C₁₋₆ alkoxy-carbonyl group). As examples of the aryloxycarbonyl group, there may be mentioned a C₆₋₂₀aryloxy-carbonyl group such as phenoxycarbonyl group, tolyloxycarbonyl group, or naphthyloxycarbonyl group (in particular, a C₆₋₁₄aryloxy-carbonyl group). The aralkyloxycarbonyl group may include, for example, a C₇₋₂₀aralkyloxy-carbonyl group such as benzyloxycarbonyl group (in particular, a C₇₋₁₈ aralkyloxy-carbonyl group).

As examples of the epoxy-containing group, there may be mentioned glycidyl group, glycidyloxy group, or other groups. The oxetanyl-containing group may include, for example, a C₁₋₁₀alkyloxetanyloxy group such as ethyloxetanyloxy group.

The substituted amino group may include, for example, a mono- or di-alkylamino group such as methylamino group, ethylamino group, dimethylamino group, or diethylamino group (in particular, a mono- or di-C₁₋₆ alkylamino group), and an acylamino group such as acetylamino group, propionylamino group, or benzoylamino group (in particular, a C₁₋₁₁acylamino group).

The organic group may be a group in which two or more organic groups are combined (or bonded). The combination of two or more organic groups may include, for example, a combination of an aliphatic hydrocarbon group and an alicyclic hydrocarbon group (such as cyclohexylmethyl group or methylcyclohexyl group), a combination of an aliphatic hydrocarbon group and an aromatic hydrocarbon group [e.g., a C₇₋₁₈ aralkyl group such as benzyl group or phenethyl group (in particular, a C₇₋₁₀aralkyl group), a C₆₋₁₀aryl-C₂₋₆alkenyl group such as cinnamyl group, a C₁₋₄alkyl-substituted aryl group such as tolyl group, and a C₂₋₄alkenyl-substituted aryl group such as styryl group], a combination of an alkoxy group and an aliphatic hydrocarbon group (such as methoxyethyl group), and a combination of an aliphatic hydrocarbon group and an aryloxy group (such as methylphenoxy group) The organic group may further have a substituent.

The substituent may include, for example, a halogen atom, oxo group, hydroxyl group, hydroperoxy group, amino group, and sulfo group.

Each of R¹ to R¹⁸ usually includes a hydrogen atom, a straight-chain or branched-chain C₁₋₆ alkyl group (in particular, a straight-chain C₁₋₃alkyl group such as methyl group). From the standpoint of rigidity, it is preferred that at least one of R¹ to R¹⁸ be a hydrogen atom. It is particularly preferred that all R¹ to R¹⁸ be hydrogen atoms.

The linkage group represented by X may include, for example, a divalent hydrocarbon group, a carbonyl group, an ether bond, an ester bond, a carbonate bond, an amide bond, a urethane bond, and a linkage group having a plurality of the above-described groups and/or bonds. The divalent hydrocarbon group may include a divalent aliphatic hydrocarbon group, a divalent alicyclic hydrocarbon group, and a divalent aromatic hydrocarbon group.

As examples of the divalent aliphatic hydrocarbon group, there may be mentioned an alkylene group, an alkenylene group, and an alkynylene group.

The alkylene group may include, for example, a C₁₋₂₀alkylene group such as methylene group, ethylene group, propylene group, trimethylene group, butylene group, tetramethylene group, hexamethylene group, isohexylene group, octamethylene group, isooctylene group, decamethylene group, or dodecamethylene group.

As examples of the alkenylene group, there may be mentioned a C₂₋₂₀alkenylene group such as vinylene group, allylene group, methallylene group, 1-propenylene group, isopropenylene group, 1-butenylene group, 2-butenylene group, butadienylene group, pentenylene group, hexenylene group, or octenylene group. The alkenylene group may be an alkenylene group in which some or all of carbon-carbon double bonds are epoxidized.

The alkynylene group may include, for example, a C₂₋₂₀alkynylene group such as ethynylene group or propynylene group.

As examples of the divalent alicyclic hydrocarbon group, there may be mentioned a C₃₋₁₂cycloalkylene group such as cyclopropylene group, cyclobutylene group, 1,2-cyclopentylene group, 1,3-cyclopentylene group, cyclopentylidene group, 1,3-cyclohexylene group, 1,4-cyclohexylene group, cyclohexylidene group, or cyclododecane-diyl group (in particular, a C₅₋₈cycloalkylene group); a C₃₋₁₂cycloalkenylene group such as cyclohexenylene group; and a C₄₋₁₅crosslinked cyclic hydrocarbon linkage group such as bicycloheptanylene group or bicycloheptenylene group. The divalent alicyclic hydrocarbon group may have an epoxy group. For example, the divalent alicyclic hydrocarbon group may be an epoxyC₅₋₁₂cycloalkylene group such as epoxycyclohexylene group.

The divalent aromatic hydrocarbon group may include, for example, a C₆₋₁₄arylene group such as phenylene group or naphthylene group.

These divalent hydrocarbon groups may have a substituent. The substituent may include, for example, the above-exemplified substituent as the substituent of the organic group represented by R¹ to R¹⁸, and a C₁₋₄alkyl group such as methyl group or ethyl group, a C₁₋₄alkoxy group such as methoxy group or ethoxy group, carbonyl group, or other substituents.

The linkage group may be a group in which two or more linkage groups are combined (or bonded or connected). The combination of two or more linkage groups may include, for example, a combination of a divalent aliphatic hydrocarbon group and a divalent alicyclic hydrocarbon group (e.g., cyclohexylenemethylene group, methylenecyclohexylene group, dicyclohexylmethane-4,4′-diyl group, and dicyclohexylpropane-4,4′-diyl group), a combination of a divalent aliphatic hydrocarbon group and a divalent aromatic hydrocarbon group (e.g., tolylene group, xylylene group, diphenylmethane-4,4′-diyl group, and diphenylpropane-4,4′-diyl group), a combination of an ester bond and divalent hydrocarbon group (e.g., carbonyloxymethylene group and carbonyloxy-hydrogenated xylyleneoxycarbonyl group), a combination of a carbonate bond and a divalent hydrocarbon group (e.g., methyleneoxycarbonyloxymethylene group and methyleneoxycarbonyloxy-hydrogenated xylylene oxycarbonyloxymethylene group), a combination of a plurality of ester bonds (e.g., a polyester bond such as a polycaprolactone), a combination of a plurality of ether bonds (e.g., a polyether bond such as a polyoxyethylene group), a combination of a plurality of ether bonds and a plurality of ester bonds (a polyetherester bond), a combination of a plurality of urethane bonds (a polyurethane bond), and a combination of an epoxycycloalkylene group and a polyester bond.

A preferred X includes a direct bond, an alkylene group (e.g., a C₁₋₄alkylene group which may have a C₁₋₄alkyl group, such as methylene group, methylmethylene group, dimethylmethylene group, or ethylene group), a group containing an ether bond (e.g., a C₁₋₄alkyleneoxyC₁₋₄alkylene group such as methyleneoxymethylene group), a combination of an ester bond and an alkylene group (e.g., a carbonyloxyC₁₋₄alkylene group such as carbonyloxymethylene group), a combination of a carbonate bond and an alkylene group (e.g., a C₁₋₄alkyleneoxycarbonyloxyC₁₋₄alkylene group such as methyleneoxycarbonyloxymethylene group), or other groups. From the standpoint of excellent sliding properties and rigidity, the direct bond is particularly preferred.

Examples of a preferred alicyclic epoxy compound include a diepoxybiC₅₋₈cycloalkyl which may have a C₁₋₄alkyl group (e.g., methyl group), such as 3,4,3′,4′-diepoxybicyclohexyl or (3,4,3′,4′-diepoxy-6-methyl)bicyclohexyl; and an epoxyC₅₋₈cycloalkylC₁₋₄alkyl(epoxy)C₅₋₈cycloalkane carboxylate which may have a C₁₋₄alkyl group, such as 3,4-epoxycyclohexylmethyl(3,4-epoxy)cyclohexanecarboxylate or 3,4-epoxy-6-methylcyclohexylmethyl(3,4-epoxy-6-methyl)cyclohexane carboxylate.

These alicyclic epoxy compounds may be used alone or in combination.

(Curing Agent)

It is preferred that the curable liquid composition (A) further contain a curing agent (or a hardener). Examples of the curing agent may include a cationic polymerization initiator (an acid generator) and a conventional curing agent [for example, an acid and an acid anhydride curing agent, an amine curing agent, polyaminoamide curing agent, an imidazole curing agent, an organic acid hydrazide curing agent, a latent curing agent (e.g., a dicyandiamide), a polymercaptan curing agent, and a phenolic curing agent].

Among these curing agents, the cationic polymerization initiator (the acid generator) or the amine curing agent is widely used. As the cationic polymerization initiator, there may be used a photoacid generator or a thermal acid generator, according to the species of the polymerization.

The photoacid generator may include, for example, a sulfonium salt (a salt of a sulfonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), and a salt of a transition metal complex ion and an anion. These photoacid generators may be used alone or in combination. Among these photoacid generators, an acid generator having a high acidity, e.g., the sulfonium salt, is preferred in light of the improvement of the reactivity and the improvement of the hardness of the cured product.

The sulfonium salt may include, for example, a triarylsulfonium salt [such as a triphenylsulfonium salt, a tri-p-tolylsulfonium salt, a tri-o-tolylsulfonium salt, a tris(4-methoxyphenyl)sulfonium salt, a 1-naphthyldiphenylsulfonium salt, a 2-naphthyldiphenylsulfonium salt, a tris(4-fluorophenyl)sulfonium salt, a tri-1-naphthylsulfonium salt, a tri-2-naphthylsulfonium salt, a tris(4-hydroxyphenyl)sulfonium salt, a diphenyl[4-(phenylthio)phenyl]sulfonium salt, a [4-(4-biphenylthio)phenyl]-4-biphenylphenylsulfonium salt, or a 4-(p-tolylthio)phenyldi-(p-phenyl)sulfonium salt]; a diarylsulfonium salt (such as a diphenylphenacylsulfonium salt, a diphenyl-4-nitrophenacylsulfonium salt, a diphenylbenzylsulfonium salt, or a diphenylmethylsulfonium salt); a monoarylsulfonium salt (such as a phenylmethylbenzylsulfonium salt, a 4-hydroxyphenylmethylbenzylsulfonium salt, or a 4-methoxyphenylmethylbenzylsulfonium salt); and a trialkylsulfonium salt (such as a dimethylphenacylsulfonium salt, a phenacyltetrahydrothiophenium salt, or a dimethylbenzylsulfonium salt). These sulfonium salts may be used alone or in combination. Among these sulfonium salts, the triarylsulfonium salt is preferred.

The anion (counter ion) for forming a salt with a cation may include, for example, SbF⁶⁻, PF⁶⁻, BF⁴⁻, a fluoroalkylfluorophosphate ion [such as (CF₃CF₂)₃PF³⁻ or (CF₃CF₂CF₂)₃PF³⁻], (C₆F₅)₄B⁻, (C₆F₅)₄Ga⁻, a sulfonate anion (such as trifluoromethanesulfonate anion, pentafluoroethanesulfonate anion, nonafluorobutanesulfonate anion, methanesulfonate anion, benzenesulfonate anion, or p-toluenesulfonate anion), (CF₃SO₂)₃C⁻, (CF₃SO₂)₂N⁻, a perhalogenate ion, a halosulfonate ion, a sulfate ion, a carbonate ion, an aluminate ion, a hexafluorobismuthate ion, a carboxylate ion, an arylborate ion, a thiocyanate ion, and a nitrate ion. Among these anions, the fluoroalkylfluorophosphate ion is preferred in light of solubility and others.

As the photoacid generator, a commercially available photoacid generator may be used. The commercially available photoacid generator may include, for example, a photoacid generator manufactured by San-Apro Ltd., such as “CPI-101A”, “CPI-110A”, “CPI-100P”, “CPI-110P”, “CPI-210S”, or “CPI-200K”.

The thermal acid generator may include, for example, an arylsulfonium salt, an aryliodonium salt, an allene-ion complex, a quaternary ammonium salt, an aluminum chelate, and a boron trifluoride amine complex. These thermal acid generators may be used alone or in combination. Among these thermal acid generators, an acid generator having a high acidity, e.g., the arylsulfonium salt, is preferred in light of the improvement of the reactivity and the improvement of the hardness of the cured product. As the anion, there may be mentioned anions as described in the photoacid generator. The anion may be an antimony fluoride ion, such as SbF⁶⁻.

As the thermal acid generator, a commercially available thermal acid generator may be used. The commercially available thermal acid generator may include, for example, a thermal acid generator manufactured by Sanshin Chemical Industry Co., Ltd. (such as “SAN-AID SI-60L”, “SAN-AID SI-60S”, “SAN-AID SI-80L”, or “SAN-AID SI-100L”) and a thermal acid generator manufactured by ADEKA Corporation (such as “SP-66” or “SP-77”).

The amine curing agent may include, for example, an aliphatic polyamine, an alicyclic polyamine, and an aromatic polyamine. Examples of the aliphatic polyamine may include ethylenediamine, diethylenetriamine, triethylenetetramine, tetraethylenepentamine, dipropylenediamine, diethylaminopropylamine, hexamethylenediamine, and polypropylenetriamine. As examples of the alicyclic polyamine, there may be mentioned menthenediamine, isophoronediamine, bis(4-amino-3-methyldicyclohexyl)methane, diaminodicyclohexylmethane, bis(aminomethyl)cyclohexane, N-aminoethylpiperazine, and 3,9-bis(3-aminopropyl)-3,4,8,10-tetraoxaspiro[5.5]undecane. Examples of the aromatic polyamine may include m-phenylenediamine, p-phenylenediamine, tolylene-2,4-diamine, tolylene-2,6-diamine, mesitylene-2,4-diamine, 3,5-diethyltolylene-2,4-diamine, 3,5-diethyltolylene-2,6-diamine, biphenylenediamine, 4,4-diaminodiphenylmethane, 2,5-naphthylenediamine, and 2,6-naphthylenediamine. These amine curing agents may be used alone or in combination. Among these amine curing agents, a widely used one includes the aliphatic polyamine (such as ethylenediamine, diethylenetriamine, triethylenediamine, tetraethylenepentamine, diethylaminopropylamine, or hexamethylenediamine), the alicyclic polyamine (such as menthenediamine or isophoronediamine), the aromatic polyamine (such as xylenediamine or m-phenylenediamine), or other curing agents.

Among these curing agents, the cationic polymerization initiator (the acid generator) is preferred in order to promote the polymerization and improve the hardness of the cured product.

The ratio of the curing agent relative to 100 parts by weight of the alicyclic epoxy compound can be selected from the range of about 0.01 to 200 parts by weight (e.g., about 0.1 to 150 parts by weight) depending on the species of the curing agent.

The ratio of the cationic polymerization initiator relative to 100 parts by weight of the alicyclic epoxy compound can be selected from the range of about 0.01 to 10 parts by weight, and is, for example, about 0.05 to 5 parts by weight, preferably about 0.1 to 3 parts by weight, and more preferably about 0.3 to 2 parts by weight (particularly about 0.5 to 1.5 parts by weight). An excessively small ratio of the cationic polymerization initiator may decelerate the progress of the curing reaction, resulting in a low hardness of the cured product. An excessively large ratio of the cationic polymerization initiator may decrease the storage stability of the composition or may cause the coloration of the cured product.

The ratio of the conventional curing agent such as the amine curing agent relative to 100 parts by weight of the alicyclic epoxy compound may, for example, be about 50 to 200 parts by weight, and preferably about 80 to 150 parts by weight.

(Leveling Agent)

The leveling agent may be any conventional leveling agent having a capability to reduce a surface tension. Examples of the conventional leveling agent may include an ethylene oxide adduct of acetylene glycol. In light of an excellent capability to reduce a surface tension, the leveling agent may preferably include a silicone-series leveling agent and a fluorine-containing leveling agent. In an embodiment of the present invention, the combination use of the alicyclic epoxy compound and the leveling agent allows the improvement of the surface smoothness and the sliding properties. Not only does the use of a specific leveling agent allow the maintenance of the hardness, but the control of the blending ratio also allows the improvement of the hardness.

The silicone-series leveling agent includes a leveling agent havingapolyorganosiloxane skeleton. The polyorganosiloxane skeleton includes a polyorganosiloxane having a monofunctional M unit (a unit typically represented by R³SiO_{1/2}), a difunctional D unit (a unit typically represented by R²SiO_{2/2}), a trifunctional T unit (a unit typically represented by RSiO_{3/2}), and/or a tetrafunctional Q unit (a unit typically represented by SiO_{4/2}). Typically, a polyorganosiloxane having the D unit is used. The polyorganosiloxane may have an organic group (R) selected from among the hydrocarbon groups exemplified as the groups R¹ to R¹⁸ of the formula (1) of the alicyclic epoxy compound. The organic group R usually includes a C₁₋₄alkyl group and/or an aryl group, preferably methyl group and/or phenyl group (in particular, methyl group) The repeating number of siloxane units (the degree of polymerization) is, for example, about 2 to 3000, preferably about 3 to 2000, and preferably about 5 to 1000.

The fluorine-containing leveling agent includes a leveling agent having a fluoroaliphatic hydrocarbon skeleton. As the fluoroaliphatic hydrocarbon skeleton, for example, there may be mentioned a fluoroC₁₋₁₀alkane, such as fluoromethane, fluoroethane, fluoropropane, fluoroisopropane, fluorobutane, fluoroisobutane, fluoro-t-butane, fluoropentane, or fluorohexane.

Each one of these fluoroaliphatic hydrocarbon skeletons has one or more fluorine atoms substituted in place of one or more hydrogen atoms on the parent skeleton. In order to improve the sliding properties and the rigidity, a perfluoroaliphatic hydrocarbon skeleton in which all hydrogen atoms on the parent skeleton have been replaced with fluorine atoms is preferred.

The fluoroaliphatic hydrocarbon skeleton may have a polyfluoroalkylene ether skeleton, which is a repeating unit through an ether bond. The fluoroaliphatic hydrocarbon group as the repeating unit may be at least one member selected from the group consisting of fluoroC₁₋₄alkylene groups, for example, fluoromethylene group, fluoroethylene group, fluoropropylene group, and fluoroisopropylene group. These fluoroaliphatic hydrocarbon groups may be the same or different from each other. The repeating number of fluoroalkylene ether units (the degree of polymerization) may be, for example, about 10 to 3000, preferably about 30 to 1000, and more preferably about 50 to 500.

Among these skeletons, the polyorganosiloxane skeleton is preferred in light of the excellent affinity with the cationic curable silicone resin.

In order to impart various functions to the cationic curable silicone resin, the leveling agent having such a skeleton may have a functional group (such as a hydrolytically condensable group, or a reactive group to an epoxy group), a radical-polymerizable group, a polyether group, a polyester group, and/or a polyurethane group. The silicone-series leveling agent may have a fluoroaliphatic hydrocarbon group, or the fluorine-containing leveling agent may have a polyorganosiloxane group.

The hydrolysable group may include, for example, hydroxysilyl group; a trihalosilyl group (such as trichlorosilyl group); a dihaloC₁₋₄alkylsilyl group (such as dichloromethylsilyl group); a dihaloarylsilyl group (such as dichlorophenylsilyl group); a halodiC₁₋₄alkylsilyl group (e.g., a chlorodiC₁₋₄alkylsilyl group such as chlorodimethylsilyl group); a triC₁₋₄alkoxysilyl group (such as trimethoxysilyl group or triethoxysilyl group); a diC₁₋₄alkoxyC₁₋₄alkylsilyl group (such as dimethoxymethylsilyl group or diethoxymethylsilyl group); a diC₁₋₄alkoxyarylsilyl group (such as dimethoxyphenylsilyl group or diethoxyphenylsilyl group); a C₁₋₄alkoxydiC₁₋₄alkylsilyl group (such as methoxydimethylsilyl group or ethoxydimethylsilyl group); a C₁₋₄alkoxydiarylsilyl group (such as methoxydiphenylsilyl group or ethoxydiphenylsilyl group); and a C₁₋₄alkoxyC₁₋₄alkylarylsilyl group (such as methoxymethylphenylsilyl group or ethoxymethylphenylsilyl group). Among them, the triC₁₋₄alkoxysilyl group, such as trimethoxysilyl group, is preferred in light of the reactivity or others.

The reactive group to an epoxy group may include, for example, a hydroxyl group, an amino group, a carboxyl group, an acid anhydride group (such as maleic anhydride group), and an isocyanate group. Among them, the hydroxyl group, the amino group, the acid anhydride group, the isocyanate group, or other groups are widely used in light of the reactivity or others. In view of easiness of handling or obtaining, the hydroxyl group is preferred.

The radical-polymerizable group may include, for example, a (meth)acryloyloxy group and a vinyl group. Among them, the (meth)acryloyloxy group is widely used.

As the polyether group, for example, there may be mentioned a polyoxyC₂₋₄alkylene group such as a polyoxyethylene group, a polyoxypropylene group, a polyoxybutylene group, or a polyoxyethylene-polyoxypropylene group. In the polyether group, the repeating number of oxyalkylene groups (the mole number of oxyalkylene groups) is, for example, about 2 to 1000, preferably about 3 to 100, and preferably about 5 to 50. Among them, a preferred one includes a polyoxyC₂₋₃alkylene group such as a polyoxyethylene group or a polyoxypropylene group (in particular, a polyoxyethylene group).

The polyester group may include, for example, a polyester group obtainable by a reaction of a dicarboxylic acid [e.g., an aromatic carboxylic acid (such as terephthalic acid) or an aliphatic carboxylic acid (such as adipic acid)] and a diol (e.g., an aliphatic diol such as ethylene glycol) and a polyester group obtainable by a ring opening polymerization of a circular ester (e.g., a lactone such as caprolactone).

The polyurethane group may include, for example, a conventional polyester-based polyurethane group and a polyether-based polyurethane group.

Each one of these functional groups may be introduced into the polyorganosiloxane skeleton or the fluoroaliphatic hydrocarbon skeleton by direct bonding or through a linkage group (for example, an alkylene group, a cycloalkylene group, an ether bond, an ester bond, an amide bond, a urethane bond, or a linkage group having a plurality of the above-mentioned groups and/or or bonds).

Among these functional groups, the hydrolytically condensable group and the reactive group to an epoxy group are preferred in the respect that the functional group can be allowed to react with the alicyclic epoxy compound to improve the hardness of the cured product. The reactive group to an epoxy group (in particular, hydroxyl group) is particularly preferred.

The hydroxyl group may be a terminal hydroxyl group of a (poly)oxyalkylene group [such as a (poly)oxyethylene group]. The leveling agent having a hydroxyl group may include, for example, a silicone-series leveling agent (e.g., a polydimethylsiloxanepolyoxyethylene) having a (poly)oxyC₂₋₃alkylene group (such as a (poly)oxyethylene group) on a side chain of a polyorganosiloxane skeleton (such as a polydimethylsiloxane); and a fluorine-containing leveling agent (e.g., a fluoroalkylpolyoxyethylene) having a fluoroaliphatic hydrocarbon group on a side chain of a (poly)oxyC₂₋₃alkylene skeleton (such as a (poly)oxyethylene).

As the silicone-series leveling agent, there may be used a commercially available silicone-series leveling agent. The commercially available silicone-series leveling agent may include, for example, a BYK series leveling agent manufactured by BYK Japan KK (e.g., “BYK-300”, “BYK-301/302”, “BYK-306”, “BYK-307”, “BYK-310”, “BYK-315”, “BYK-313”, “BYK-320”, “BYK-322”, “BYK-323”, “BYK-325”, “BYK-330”, “BYK-331”, “BYK-333”, “BYK-337”, “BYK-341”, “BYK-344”, “BYK-345/346”, “BYK-347”, “BYK-348”, “BYK-349”, “BYK-370”, “BYK-375”, “BYK-377”, “BYK-378”, “BYK-UV3500”, “BYK-UV3510”, “BYK-UV3570”, “BYK-3550”, “BYK-SILCLEAN3700”, and “BYK-SILCLEAN3720”), an AC series leveling agent manufactured by Algin Chemie (e.g., “AC FS180”, “AC FS360”, and “AC S20”), a POLYFLOW series leveling agent manufactured by Kyoeisha Chemical Co., Ltd. (e.g., “POLYFLOW KL-400X”, “POLYFLOW KL-400HF”, “POLYFLOW KL-401”, “POLYFLOW KL-402”, “POLYFLOW KL-403”, and “POLYFLOW KL-404”), a KP series leveling agent manufactured by Shin-Etsu Chemical Co., Ltd. (e.g., “KP-323”, “KP-326”, “KP-341”, “KP-104”, “KP-110”, and “KP-112”), and a leveling agent manufactured by Dow Corning Toray Co., Ltd. (e.g., “LP-7001”, “LP-7002”, “8032ADDITIVE”, “57ADDITIVE”, “L-7604”, “FZ-2110”, “FZ-2105”, “67ADDITIVE”, “8618ADDITIVE”, “3ADDITIVE”, and “56ADDITIVE”).

As the fluorine-containing leveling agent, there may be used a commercially available fluorine-containing leveling agent. The commercially available fluorine-containing leveling agent may include, for example, an OPTOOL series leveling agent manufactured by Daikin Industries, Ltd. (“DSX”, “DAC-HP”), a SURFLON series leveling agent manufactured by AGC Seimi Chemical Co., Ltd. (e.g., “S-242”, “S-243”, “S-420”, “S-611”, “S-651”, and “S-386”), a BYK series leveling agent manufactured by BYK Japan KK (e.g., “BYK-340”), an AC series leveling agent manufactured by Algin Chemie (e.g., “AC 110a” and “AC 100a”), a MEGAFACE series leveling agent manufactured by DIC Corporation (e.g., “MEGAFACE F-114”, “MEGAFACE F-410”, “MEGAFACE F-444”, “MEGAFACE EXP TP-2066”, “MEGAFACE F-430”, “MEGAFACE F-472SF”, “MEGAFACE F-477”, “MEGAFACE F-552”, “MEGAFACE F-553”, “MEGAFACE F-554”, “MEGAFACE F-555”, “MEGAFACE R-94”, “MEGAFACE RS-72-K”, “MEGAFACE RS-75”, “MEGAFACE F-556”, “MEGAFACE EXP TF-1367”, “MEGAFACE EXP TF-1437”, “MEGAFACE F-558”, and “MEGAFACE EXP TF-1537”, a FC series leveling agent manufactured by Sumitomo 3M Limited (e.g., “FC-4430” and “FC-4432”), a FTERGENT series leveling agent manufactured by Neos Company Limited (e.g., “FTERGENT 100”, “FTERGENT 100C”, “FTERGENT 110”, “FTERGENT 150”, “FTERGENT 150CH”, “FTERGENT A-K”, “FTERGENT 501”, “FTERGENT 250”, “FTERGENT 251”, “FTERGENT 222F”, “FTERGENT 208G”, “FTERGENT 300”, “FTERGENT 310”, and “FTERGENT 400SW”), and a PF series leveling agent manufactured by Kitamura Chemicals Co., Ltd. (e.g., “PF-136A”, “PF-156A”, “PF-151N”, “PF-636”, “PF-6320”, “PF-656”, “PF-6520”, “PF-651”, “PF-652”, and “PF-3320”).

These leveling agents may be used alone or in combination. For example, a plural kind of the silicone-series leveling agents may be used in combination, a plural kind of the fluorine-containing leveling agents may be used in combination, or the silicone-series leveling agent and the fluorine-containing leveling agent may be used in combination. Among these leveling agents, a silicone-series leveling agent having a hydroxyl group is preferred, since the leveling agent has an excellent affinity with the alicyclic epoxy compound, can be allowed to react with an epoxy group, and can improve the hardness or external appearance of the cured product.

The silicone-series leveling agent having a hydroxyl group may include, for example, a polyether-modified polyorganosiloxane in which a main chain or side chain of a polyorganosiloxane skeleton (such as a polydimethylsiloxane) has a polyether group; a polyester-modified polyorganosiloxane in which a main chain or side chain of a polyorganosiloxane skeleton has a polyester group; and a silicone-modified (meth)acrylic resin in which a (meth)acrylic resin is modified with a polyorganosiloxane. For each one of these leveling agents, the polyorganosiloxane skeleton may have a hydroxyl group, or the polyether group, the polyester group, or the (meth)acryloyl group may have a hydroxyl group. As the leveling agent, for example, there may be used “BYK-370”, “BYK-SILCLEAN3700”, “BYK-SILCLEAN3720” manufactured by BYK Japan KK.

The ratio of the leveling agent relative to 100 parts by weight of the alicyclic epoxy compound can be selected from the range of about 0.01 to 20 parts by weight, and, for example, is about 0.05 to 15 parts by weight, preferably about 0.1 to 10 parts by weight, and more preferably about 0.2 to 5 parts by weight. The leveling agent in an excessively small ratio may decrease the sliding properties of the cured product. The leveling agent in an excessively large ratio may decrease the hardness of the cured product.

In particular, the ratio of the silicone-series leveling agent relative to 100 parts by weight of the alicyclic epoxy compound may be, for example, about 0.1 to 10 parts by weight, preferably about 0.2 to 5 parts by weight, and more preferably about 0.3 to 3 parts by weight (particularly about 0.5 to 2 parts by weight). The ratio of the fluorine-containing leveling agent relative to 100 parts by weight of the alicyclic epoxy compound may be, for example, about 0.05 to 5 parts by weight, preferably about 0.1 to 3 parts by weight, and more preferably about 0.2 to 1 part by weight (particularly about 0.3 to 0.8 parts by weight). The ratio adjustment of the leveling agent within such a range can improve not only the sliding properties of the cured product but also the hardness of the cured product; it has not been expected before that the leveling agent improves the hardness of the cured product.

(Other Additives)

The curable liquid composition (A) may contain another curable resin. Another curable resin may include, for example, another epoxy resin (an epoxy resin other than the alicyclic epoxy compound), an oxetane resin, and a vinyl ether resin. These curable resins may be used alone or in combination. Among these curable resins, another epoxy resin is preferred in view of reactivity, miscibility, and others. As another epoxy resin, there may be mentioned, for example, a glycidyl ether-based epoxy resin, a glycidyl ester-based epoxy resin, a glycidylamine-based epoxy resin, and a long-chain aliphatic epoxy resin. The ratio of another curable resin relative to 100 parts by weight of the alicyclic epoxy compound is about not more than 100 parts by weight, for example, about not more than 50 parts by weight (e.g., about 1 to 50 parts by weight), preferably about not more than 30 parts by weight (e.g., about 5 to 30 parts by weight).

The curable liquid composition (A) may contain any conventional additive that does not have a bad influence on sliding properties or rigidity. The conventional additive may include, for example, a curing accelerator (e.g., an imidazole compound, an alkali metal or alkaline earth metal alkoxide, a phosphine compound, an amide compound, a Lewis acid complex compound, a sulfur compound, a boron compound, and a condensable organic metal compound), a filler (e.g., an inorganic filler such as titanium oxide or alumina), a stabilizer (e.g., an antioxidant, an ultraviolet absorber, a light stabilizer, and a heat stabilizer), a plasticizer, a lubricant, an antifoaming agent, an antistatic agent, and a flame retardant. These additives may be used alone or in combination. The total ratio of these additives relative to 100 parts by weight of the alicyclic epoxy compound is about not more than 100 parts by weight, for example, about not more than 30 parts by weight (e.g., about 0.01 to 30 parts by weight) and preferably about not more than parts by weight (e.g., about 0.1 to 10 parts by weight).

The curable liquid composition (A) may further contain an organic solvent. Examples of the organic solvent may include a ketone (such as acetone, methyl ethyl ketone, methyl isobutyl ketone, or cyclohexanone), an ether (such as dioxane or tetrahydrofuran), an aliphatic hydrocarbon (such as hexane), an alicyclic hydrocarbon (such as cyclohexane), an aromatic hydrocarbon (such as benzene or toluene), a halocarbon (such as dichloromethane or dichloroethane), an ester (such as methyl acetate or ethyl acetate), water, an alcohol (such as ethanol, isopropanol, butanol, or cyclohexanol), a cellosolve (such as methyl cellosolve or ethyl cellosolve), a cellosolve acetate, and an amide (such as dimethylformamide or dimethylacetamide). The solvents may be used alone or in combination.

The curable liquid composition (A) has a nonlimiting solid content weight so that the curable liquid composition may have a viscosity suitable for the process for forming the layer.

(B) First Layer

The first layer contains a polyamideimide resin. The polyamideimide resin enables the heat resistance of the heat-resistant layer, which covers the substrate, to be improved and also enables the adhesion of the heat-resistant layer to the substrate to be improved. The polyamideimide resin is a polymer having an imide bond and an amide bond in a main chain thereof. The polyamideimide resin may be a polyamideimide obtainable by allowing a tricarboxylic anhydride (or a halide thereof, a lower alkyl ester thereof, or other reactive derivatives) to react with a polyisocyanate, or may be a polyamideimide obtainable by allowing a tricarboxylic anhydride to react with a polyamine to form a product having an imide bond and then allowing the product to react with a polyisocyanate for amidation.

The polyamideimide resin usually includes a resin obtainable by using trimellitic anhydride as the tricarboxylic anhydride. For example, the polyamideimide resin may be a resin having a repeating unit represented by the formula (2):

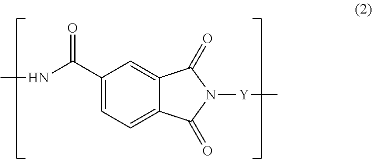

wherein Y represents a group containing a divalent hydrocarbon group.

Examples of the divalent hydrocarbon group in the group Y of the above formula (2) may include the divalent hydrocarbon group exemplified in the group X of the above formula (1). The divalent hydrocarbon group may be a C₁₋₁₀ alkylene group such as ethylene group or a C₅₋₈cycloalkylene group such as cyclohexylene group. In light of heat resistance, it is preferred that the group Y contain a divalent aromatic hydrocarbon group such as phenylene group or naphthylene group. The group containing the divalent aromatic hydrocarbon group may be a group having a plurality of divalent aromatic hydrocarbon groups (e.g., 1,4-phenylene groups) bonded by direct bonding or through a linkage group. Examples of the linkage group may include an alkylene group (e.g., a C₁₋₄alkylene group such as methylene group, ethylene group, or dimethylmethylene group (propane-2,2-diyl group)); a carbonyl group; a sulfonyl group; an ether bond; and a thioether (sulfide) bond. In this group, the divalent aromatic hydrocarbon group and the alkylene group may have a substituent (for example, a C₁₋₄alkyl group such as methyl group or ethyl group, a C₁₋₄alkoxy group such as methoxy group or ethoxy group, a halogen atom such as chlorine atom or fluorine atom, and hydroxyl group).

Examples of the group Y may include a phenylene group (such as 1,4-phenylene group or 1,3-phenylene group), a naphthylene group (such as 1,5-naphthylene group or 2,6-naphthylene group), a biphenylene group (such as 4,4′-biphenylene group or 3,3′-biphenylene group), a bisphenol residue [such as diphenylmethane-4,4′-diyl group (bisphenol F residue), dimethyldiphenylmethane-4,4′-diyl group (bisphenol A residue), diphenylcarbonyl-4,4′-diyl group, diphenylsulfonyl-4,4′-diyl group (bisphenol S residue), diphenylthio-4,4′-diyl group, or diphenyloxy-4,4′-diyl group], a group having these groups further bonded by direct bonding or through a linkage group as described above (such as a carbonyl group, a sulfonyl group, an ether bond, or a thioether bond), or a group in which these groups have a benzene ring having a substituent as described above. These groups may be used alone or in combination.

Among them, the phenylene group, the biphenylene group, the bisphenol residue, or other groups are widely used. A preferred one includes a biphenylene group or a diphenylmethane-4,4′-diyl group (bisphenol F residue), each having a benzene ring which may have a substituent (e.g., a halogen atom such as fluorine atom or chlorine atom, a C₁₋₃alkyl group such as methyl group, and a C₁₋₃alkoxy group such as methoxy group).

The polyamideimide resin has a number-average molecular weight of, for example, not less than 1,000 in terms of polystyrene in gel permeation chromatography (GPC). For example, the number-average molecular weight is about 3,000 to 500,000, preferably about 5,000 to 300,000, and more preferably about 8,000 to 100,000 (particularly about 10,000 to 50,000). The molecular weight less than these values may fail to provide intended heat resistance or mechanical properties.

The polyamideimide resin may have a glass transition temperature of not lower than 150° C. The glass transition temperature is, for example, about 180 to 400° C., preferably about 200 to 380° C., and more preferably about 250 to 350° C. (particularly about 280 to 330° C.). The glass transition temperature less than these values may fail to provide intended heat resistance. In the present invention, the glass transition temperature of the polyamideimide resin can be measured by a differential scanning calorimeter (DSC).

The first layer may contain a solid lubricant in addition to the polyamideimide resin. The solid lubricant may include a conventional solid lubricant, for example, a fluorine compound (e.g., a fluorocarbon resin such as polytetrafluoroethylene, and graphite fluoride), a boron compound (e.g., boron nitride), a metal sulfide (e.g., a molybdenum sulfide such as molybdenum disulfide, and a tungsten sulfide such as tungsten disulfide), a carbon material (e.g., graphite and carbon black), a metal simple substance (e.g., silver, lead, and nickel), a mica, an organic molybdenum compound, and a melamine cyanurate. These solid lubricants may be used alone or in combination. Among these solid lubricants, the fluorine compound (in particular, a polytetrafluoroethylene), the metal sulfide (in particular, molybdenum disulfide), and the carbon material (in particular, graphite) are preferred.

The ratio of the solid lubricant relative to 100 parts by weight of the polyamideimide resin is about not more than 500 parts by weight (e.g., about 0.1 to 500 parts by weight, and preferably about 10 to 200 parts by weight). The solid lubricant content more than these ratios may fail to provide intended mechanical properties of the solidified coating film.

The first layer may contain the solid lubricant at the above-mentioned ratio according to purposes. From the standpoint of the adhesion to the substrate, it is preferred that the first layer have no solid lubricant.

The first layer may contain another additive that does not have a bad influence on heat resistance or sliding properties. A conventional additive may include a curing agent (e.g., an epoxy resin), a filler (e.g., an inorganic filler such as titanium oxide or alumina), a stabilizer (e.g., an antioxidant, an ultraviolet absorber, a light stabilizer, and a heat stabilizer), a plasticizer, an antifoaming agent, an antistatic agent, a flame retardant, or other additives. These additives may be used alone or in combination. The total ratio of these additives relative to 100 parts by weight of the polyamideimide resin is about not more than 100 parts by weight, for example, about not more than 30 parts by weight (e.g., about 0.01 to 30 parts by weight), and preferably about 10 parts by weight (e.g., about 0.1 to 10 parts by weight).

The first layer is usually obtainable by solidifying a liquid composition (B) containing the polyamideimide resin. The liquid composition (B) may contain water or an organic solvent. Examples of the organic solvent may include an amide (e.g., an N-mono- or di-C₁₋₄alkylformamide such as N-methylformamide or N,N-dimethylformamide; an N-mono- or di-C₁₋₄alkylacetamide such as N-methylacetamide or N,N-dimethylacetamide; and a N-methylpyrrolidone), a ketone (such as acetone, methyl ethyl ketone, methyl isobutyl ketone, or cyclohexanone), an ether (such as dioxane or tetrahydrofuran), an aliphatic hydrocarbon (such as hexane), an alicyclic hydrocarbon (such as cyclohexane), an aromatic hydrocarbon (such as benzene or toluene), a halocarbon (such as dichloromethane or dichloroethane), an ester (such as methyl acetate or ethyl acetate), an alcohol (such as methanol, ethanol, isopropanol, butanol, or cyclohexanol), a cellosolve (such as methylcellosolve or ethylcellosolve), and a cellosolve acetate. These solvents may be used alone or in combination. Among these solvents, a good solvent to the polyamideimide resin, such as N-methylpyrrolidone, is preferred.

The liquid composition (B) has a nonlimiting solid content weight so that the liquid composition (B) may have a viscosity suitable for the process for forming the layer. For example, the solid content of the liquid composition (B) may be selected from the range of about 1 to 80% by weight.

[Characteristics of Automotive Part]

The second layer has a high hardness. The second layer may have an indentation hardness measured by a microhardness tester of not less than 300 N/mm² (e.g., about 300 to 1000 N/mm²), preferably not less than 450 N/mm² (e.g., about 450 to 800 N/mm²), and more preferably not less than 550 N/mm² (e.g., about 550 to 700 N/mm²) The indentation hardness less than these values may make it difficult to maintain the abrasion resistance of the second layer over a long period of time. In the present invention, the indentation hardness can be measured by the method described in after-mentioned Examples.

The first layer may have an average thickness of, for example, not less than 0.5 μm, e.g., about 0.5 to 30 μm, preferably about 0.8 to 10 μm, and more preferably about 1 to 5 μm (particularly about 1.5 to 3 μm). The thickness of the first layer less than these values may fail to provide intended heat resistance and intended adhesion to a metallic molded product and/or the second layer.

The second layer may have an average thickness of, for example, not less than 1 μm, e.g., about 1 to 100 μm, preferably about 5 to 80 μm, and more preferably about 10 to 50 μm. The thickness of the second layer less than these values may fail to provide intended sliding properties and intended rigidity.

The average thickness of the second layer may, for example, be about 2 to 100 times, preferably about 3 to 80 times, and more preferably 5 to 50 times (particularly about 10 to 30 times) as large as the average thickness of the first layer.

In an embodiment of the present invention, the average thickness of the first layer and that of the second layer can, for example, be determined from the average value of any 10 points measured by an optical thickness meter.

[Process for Producing Automotive Part]

The automotive part includes the substrate and the heat-resistant layer disposed on the substrate. The first layer of the heat-resistant layer is bonded or adheres to the substrate. The first layer of the heat-resistant layer has not only an excellent adhesion to the second layer but also an excellent adhesion to the substrate and as such, is bonded to the substrate with no adhesive layer between the first layer and the substrate. In an embodiment of the present invention, the automotive part may thus be produced by applying (or coating) the liquid composition (B) on a surface of the substrate and solidifying the liquid composition to form a first layer, and applying (or coating) the curable liquid composition (A) on a surface of the resulting first layer and curing the curable liquid composition to form a second layer.

For the step of forming the first layer, the method for applying the liquid composition (B) may include a conventional method, for example, roll coating, air knife coating, blade coating, rod coating, reverse coating, bar coating, comma coating, die coating, gravure coating, screen coating, spraying, and spin coating. Among these methods, blade coating, bar coating, and gravure coating are widely used.

The solidification of the liquid composition (B) may be carried out by natural drying. In order to improve the strength of the first layer and the adhesion of the first layer to the substrate, it is preferred that the solidification be carried out by heat drying. The heating temperature for drying may, for example, be not lower than 60° C. (e.g., about 60 to 300° C.).

In an embodiment of the present invention, in order to further improve the strength of the first layer and the adhesion of the first layer to the substrate, it is particularly preferred that the solidification of the liquid composition (B) be carried out by heat drying (preheating) and then baking.

The preheating temperature is, for example, about 40 to 150° C., preferably about 50 to 120° C., and more preferably about 60 to 100° C. (particularly about 70 to 90° C.). The preheating time may be not shorter than 3 minutes (e.g., about 3 minutes to 2 hours), preferably not shorter than 5 minutes (e.g., about 5 minutes to 1 hour), and more preferably not shorter than 8 minutes (e.g., about 8 to 30 minutes).

The baking temperature may be not lower than 120° C., for example, about 120 to 300° C., preferably about 150 to 280° C., and more preferably about 160 to 250° C. (particularly about 180 to 230° C.). Too low a baking temperature may reduce the strength of the first layer and the adhesion of the first layer to the substrate. The baking time may be not shorter than 1 minute (e.g., about 1 minute to 3 hours), preferably not shorter than 10 minutes (e.g., about 10 minutes to 2 hours), and more preferably not shorter than 30 minutes (e.g., 30 minutes to 1.5 hours).

The baking treatment for forming the first layer may be a heating treatment for forming the second layer in the step of forming the second layer (for example, an aging treatment in the step of forming the second layer described later). In that case, the aging treatment for forming the second layer also serves as the baking treatment of the first layer. From the standpoint of the improvement in the surface smoothness of the second layer, it is preferred that the baking treatment for forming the first layer be carried out not in the step of forming the second layer but in the step of forming the first layer.

In the step of forming the second layer, as the method for applying the curable liquid composition (A), there may be used the same manner as the applying method in the step of forming the first layer. A widely used method includes blade coating, bar coating, gravure coating, or other methods.

In the step of forming the second layer, the curable liquid composition (A) may be heat-dried (preheated) before curing treatment. The preheating temperature is, for example, about 40 to 150° C., preferably about 50 to 120° C., and more preferably about 60 to 100° C. (particularly about 70 to 90° C.). The preheating time may be not shorter than 10 seconds (e.g., about 10 seconds to 10 minutes), preferably not shorter than 20 seconds (e.g., about 20 seconds to 5 minutes), and more preferably not shorter than 30 seconds (e.g., about 30 seconds to 2 minutes).

In the curing treatment, the curable liquid composition (A) may be cured (or hardened) by irradiation with an active energy ray or by heating, depending on the species of the curing agent. Among them, the curable liquid composition (A) may usually be cured by irradiation with an active energy ray.

As the active energy ray, heat and/or a light energy ray may be used. In particular, the irradiation with the light energy ray is useful. As the light energy ray, there may be used a radioactive ray (such as gamma ray or X-ray), an ultraviolet ray, a visible ray, an electron beam (EB), or other rays. The light energy ray usually includes an ultraviolet ray or an electron beam. In particular, for an application which requires a high weather resistance, the electron beam irradiation may be used because of polymerization without any curing agent.

For the ultraviolet ray, a light source may include, for example, a Deep UV lamp, a low-pressure mercury lamp, a high-pressure mercury lamp, a superhigh-pressure mercury lamp, a halogen lamp, and a laser light source (a light source such as a helium-cadmium laser or an excimer laser). The quantity of the irradiation light (the irradiation energy), which depends on the thickness of the coating film, may be, for example, about 50 to 10000 mJ/cm², preferably about 70 to 5000 mJ/cm², and more preferably about 100 to 1000 mJ/cm². In order to improve the adhesion to a two- or three-dimensional molded product, the quantity of light or the irradiation time may be increased. The quantity of the irradiation light may be, for example, about 300 to 10000 mJ/cm² (particularly about 400 to 3000 mJ/cm²).

For the electron beam, an exposure source (e.g., an electron beam irradiation apparatus) can be used for the electron beam irradiation. The radiation dose (dose), which depends on the thickness of the coating film, is, for example, about 1 to 200 kGy (kilogray), preferably about 5 to 150 kGy, and more preferably about 10 to 100 kGy (particularly about 20 to 80 kGy). The acceleration voltage is, for example, about 10 to 1000 kV, preferably about 50 to 500 kV, and more preferably about 100 to 300 kV.

The irradiation with the active energy ray (in particular, the electron beam) may optionally be conducted in an atmosphere of an inactive gas (for example, nitrogen gas, argon gas, and helium gas).

After the curing by the active energy ray, the cured second layer may be heat-treated (annealed or aged) In the aging treatment, the heating temperature is, for example, about 30 to 250° C., preferably about 50 to 220° C., and more preferably about 60 to 200° C. (particularly about 120 to 160° C.). The heating time is, for example, about 10 minutes to 10 hours, preferably about 30 minutes to 5 hours, and more preferably 45 minutes to 3 hours.

In a case where the curable resin composition is thermally cured by using a thermal cationic polymerization initiator, the heating temperature is, for example, about 30 to 200° C., preferably about 50 to 190° C., and more preferably about 60 to 180° C.

As the curing treatment, a curing treatment by the active energy ray such as an ultraviolet ray is preferred in view of applicability to various substrates.

The substrate is usually formed of a metal. Examples of the metal may include, but should not be limited to, aluminum, iron, nickel, copper, and chromium. The metal may be a simple substance of the metal described above or may be an alloy of the metals described above (for example, stainless steel, and steel). Further, the metal may be subjected to a surface treatment for rust proofing, for example, a plating treatment such as galvanization. Among these metals, an aluminum- or iron-containing metal is widely used. The aluminum-containing metal (such as a simple aluminum substance or an aluminum alloy) is preferred.

The automotive part may be utilized as a part for an internal combustion which requires weather resistance in addition to heat resistance and sliding properties. Examples of the automotive part may include an engine part, e.g., a coating member of a piston skirt; a sliding part such as a cam bearing, a crank bearing, or a connection rod bearing; a shaft part such as a camshaft or a crankshaft; a valve-gear sliding member such as a roller rocker, a rocker arm, a hydraulic lash adjuster, or a valve lifter; a chain-driven sliding part such as a chain guide, a chain damper, or a chain slipper; an engine auxiliary part such as a bearing portion of a vane or trochoid oil pump or a bearing portion of an alternator; or other transmission bearing parts.

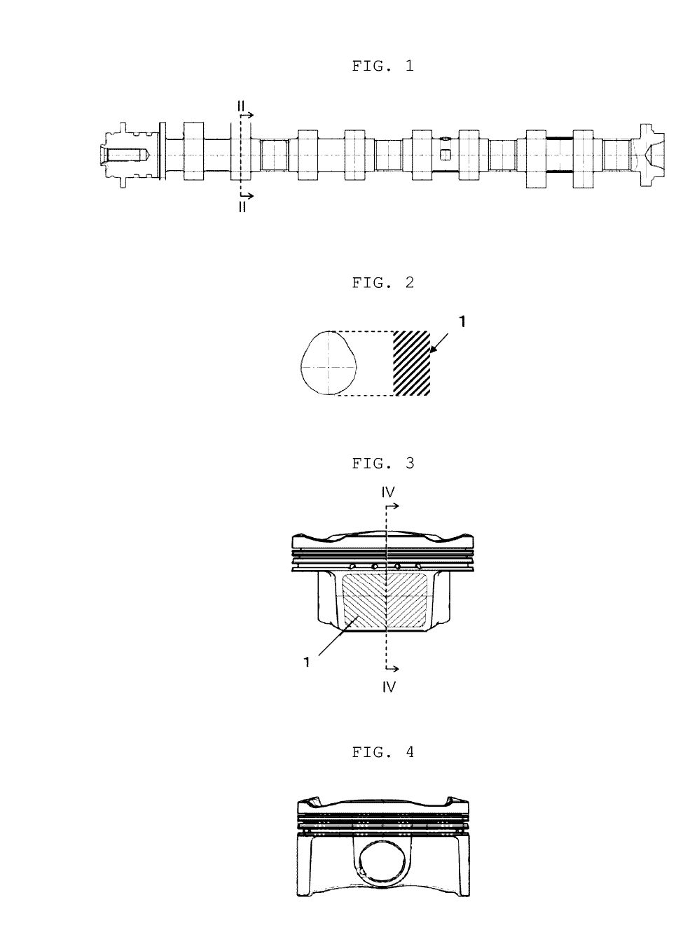

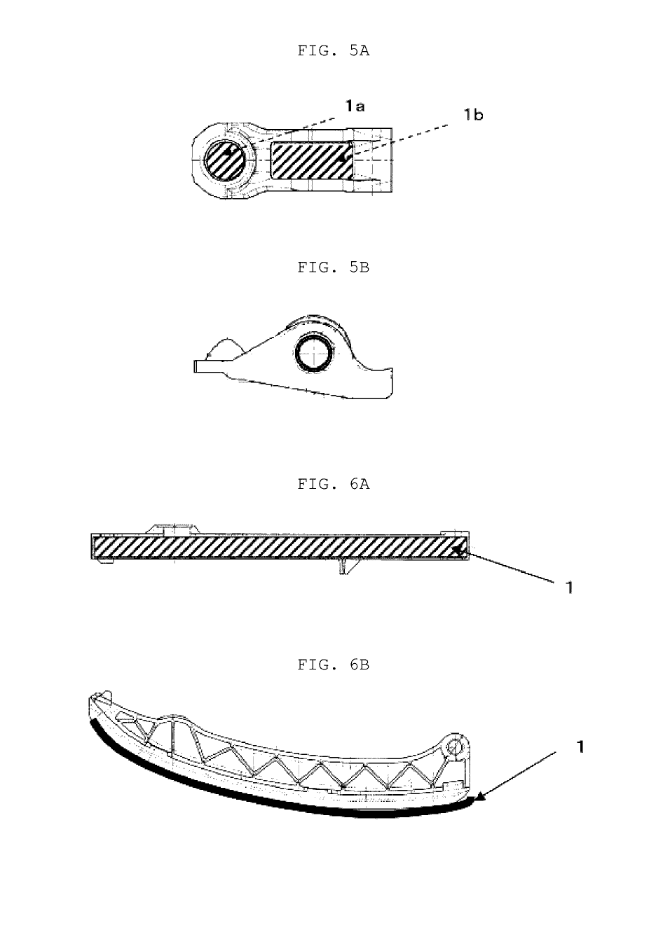

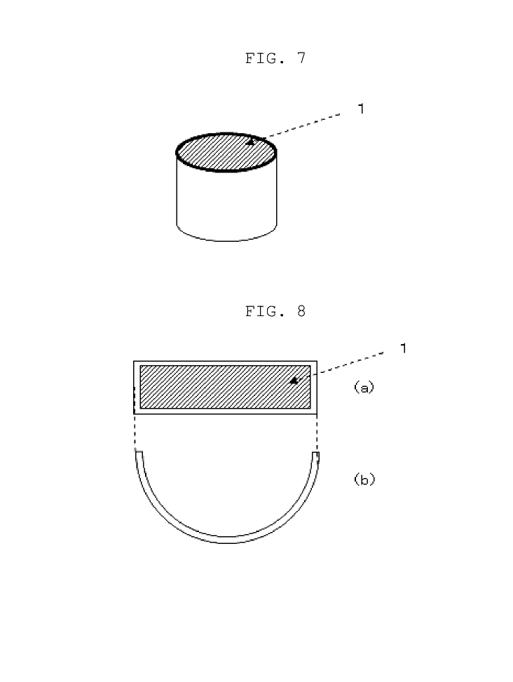

The heat-resistant layer is disposed (or laminated or covered) on the surface of the substrate. The heat-resistant layer may be disposed on the whole surface of the substrate or may be disposed on a portion of the surface of the substrate. In embodiments of the present invention as shown in FIGS. 1 to 8, the automotive part has the heat-resistant layer on a partial area of the substrate. FIGS. 1 and 2 are a schematic view of an example cam nose portion having a heat-resistant layer and a cross-sectional view taken along line II-II in FIG. 1, respectively. In FIG. 1, each of projections regularly arranged along an axial direction has a heat-resistant layer 1 on a surface thereof. FIGS. 3 and 4 are a schematic view of an example piston skirt portion having a heat-resistant layer and a cross-sectional view taken along line IV-IV in FIG. 3, respectively. The piston skirt portion has a heat-resistant layer 1 on a side face thereof. FIG. 5A is a schematic view of an example roller rocker portion having a heat-resistant layer. FIG. 5B is a side view of FIG. 5A. The roller portion has a heat-resistant layer 1a thereon, and the arm portion has a heat-resistant layer 1b thereon. FIG. 6A is a schematic view of an example chain damper portion having a heat-resistant layer. FIG. 6B is a partial cross-sectional view of FIG. 6A. The chain damper portion has an exterior portion having a heat-resistant layer 1 thereon. FIG. 7 is a schematic view of an example valve lifter portion having a heat-resistant layer. The valve lifter portion has a heat-resistant layer 1 on an upper surface thereof. FIG. 8 is a schematic view of an example cam and crank bearing portion having a heat-resistant layer. The crank bearing portion has a heat-resistant layer 1 on a surface thereof. In these embodiments, each portion on which the corresponding heat-resistant layer is disposed is a nonlimiting example.

### EXAMPLES

The following examples are intended to describe this invention in further detail and should by no means be interpreted as defining the scope of the invention. Details of raw materials used in Examples and Comparative Examples are as follows. The laminates obtained in Examples and Comparative Examples were evaluated for the following items.

[Raw Materials]

(Resins for Topcoat Layer)

Alicyclic epoxy compound A: 3,4,3′,4′-Diepoxybicyclohexyl

Alicyclic epoxy compound B: 3,4-Epoxycyclohexylmethyl (3,4-epoxy)cyclohexanecarboxylate, “CELLOXIDE 2021P” manufactured by Daicel Corporation

Bisphenol A-based epoxy resin: “jER828” manufactured by Mitsubishi Chemical Corporation

(Resins for Primer Layer)

Polyamideimide A: “VYLOMAX HR-11NN” manufactured by TOYOBO CO., LTD.

Polyamideimide B: “Drycoat 3500” manufactured by SUMICO LUBLICANT CO., LTD.

Acrylic oligomer: “RAYMAGIC” manufactured by Kanae Paint Co., Ltd.

(Additives)

Curing agent: [4-(4-Biphenylthio)phenyl]-4-biphenylphenylsulfonium tris(pentafluoroethyl) trifluorophosphate

Leveling agent: Solution of polyether-modified polydimethylsiloxane having hydroxyl groups, “BYK-SILCLEAN3720” manufactured by BYK Japan KK

[Thickness of Coating Film]

The thickness of a cured coating film on an aluminum plate was measured by a dual-type coating thickness tester (“LZ-990” manufactured by Kett Electric Laboratory).

[Adhesion Test (Cross-Cut Test)]

A cured coating film on an aluminum plate was simply evaluated for adhesion as follows. Six parallel cuts spaced 2 mm were introduced to the coating film. The process was intersectingly repeated at an angle of 900 so that a lattice pattern was formed, consisting of 25 single square sections. A pressure-sensitive tape was applied over the pattern and pulled off rapidly. Thereafter, among the 25 square sections, the number of square sections of which the area not less than 80% remained was counted.

[Boiling Water Resistance]

A coated aluminum plate (composite molded product) was dipped into purified water in a stainless steel (SUS) beaker by suspending the plate with a clip. The purified water was heated by a hot plate and was boiled for 5 hours. Thereafter, the state of the coated surface was evaluated visually and on the basis of the adhesion test.

[Scratch Test]

A coating film on an aluminum plate was evaluated for the durability and adhesion by a scratch test. The scratch test was carried out by a straight scratch test using a Macro Mechanical Tester (manufactured by NANOVEA) at a load ranging from 0.3 N to 50 N, a load-carrying rate of 50 N/min., and a scratch rate of 10 mm/min. From the trace observation of sliding, the deformation starting load of the coating film and the delamination load thereof were evaluated.

[Indentation Hardness]

The indentation hardness was measured under the following conditions by a microhardness tester (“ENT-2100” manufactured by ELIONIX INC.), and the average value (n=9) was determined.

Measurement mode: load-unload mode

Surface detection: slope (2.0)

Load curve: 5 mN over 10 seconds (linear)

Creep: 5 mN for 10 seconds

Unload curve: 0 mN over 10 seconds (linear)

Tip: Berkovich tip

### Example 1

An aluminum plate was degreased with acetone. The polyamideimide A was applied on the degreased aluminum plate with the use of a wire bar #3, and was then preheated (prebaked) at 80° C. for 15 minutes and baked at 200° C. for 60 minutes to give a primer layer (a first layer).

As a coating composition for a topcoat layer (a second layer), a composition containing 100 parts by weight of the alicyclic epoxy compound A, 0.25 parts by weight of the curing agent, and 1 part by weight of the leveling agent was provided. The coating composition was applied on the resulting primer layer with the use of a wire bar #20 and was then prebaked at 80° C. for one minute. The prebaked product was then ultraviolet-treated at a cumulative quantity of 400 mJ/cm² by irradiation with an ultraviolet ray using a belt-conveyor high-pressure mercury lamp (“UVC-02516S1” manufactured by USHIO INC.) at a lamp outlet of 120 W and a conveyor speed of 5.5 m/min. Finally, the UV-treated product was heat-treated (aged) at 150° C. for one hour for curing the UV-treated coating composition to give a composite molded product having the primer layer and the topcoat layer (a coated aluminum plate). The coating film had an average thickness (a total thickness of the primer layer and the topcoat layer) of 37 μm.

### Example 2

A composite molded product was produced in the same manner as Example 1 except that the aging treatment of the coating composition was carried out at an aging temperature of 200° C. The coating film had an average thickness of 36 μm.

### Example 3

An aluminum plate was degreased with acetone. The polyamideimide A was applied on the degreased aluminum plate with the use of a wire bar #3 and was then heated at 80° C. for 60 minutes to give a primer layer (a first layer).

As a coating composition for a topcoat layer (a second layer), a composition containing 100 parts by weight of the alicyclic epoxy compound A, 0.25 parts by weight of the curing agent, and 1 part by weight of the leveling agent was provided. The coating composition was applied on the resulting primer layer with the use of a wire bar #20 and was then prebaked at 80° C. for one minute. The prebaked product was then ultraviolet-treated at a cumulative quantity of 400 mJ/cm² by irradiation with an ultraviolet ray using a belt-conveyor high-pressure mercury lamp (“UVC-02516S1” manufactured by USHIO INC.) at a lamp outlet of 120 W and a conveyor speed of 5.5 m/min. Finally, the UV-treated product was heat-treated (aged) at 150° C. for one hour and at 200° C. for another one hour for curing the UV-treated coating composition to give a composite molded product having the primer layer and the topcoat layer (a coated aluminum plate). The coating film had an average thickness (a total thickness of the primer layer and the topcoat layer) of 31 μm.

### Example 4

A composite molded product was produced in the same manner as Example 3 except that the aging treatment of the coating composition was carried out at an aging temperature of 200° C. for one hour. The coating film had an average thickness of 36 μm.

### Example 5

A composite molded product was produced in the same manner as Example 1 except that the polyamideimide B was used instead of the polyamideimide A. The coating film had an average thickness of 29 μm.

### Example 6

A composite molded product was produced in the same manner as Example 1 except that the alicyclic epoxy compound B was used instead of the alicyclic epoxy compound A. The coating film had an average thickness of 31 μm.

### Comparative Example 1

An aluminum plate was degreased with acetone. As a coating composition for a topcoat layer, a composition containing 100 parts by weight of the alicyclic epoxy compound A and 0.25 parts by weight of the curing agent was provided. The coating composition was applied on the degreased aluminum plate with the use of a wire bar #20 and was then prebaked at 80° C. for one minute. The prebaked product was then ultraviolet-treated at a cumulative quantity of 400 mJ/cm² by irradiation with an ultraviolet ray using a belt-conveyor high-pressure mercury lamp (“UVC-02516S1” manufactured by USHIO INC.) at a lamp outlet of 120 W and a conveyor speed of 5.5 m/min. Finally, the UV-treated product was heat-treated (aged) at 150° C. for one hour for curing the UV-treated coating composition to give a composite molded product having the topcoat layer alone (a coated aluminum plate). The coating film had an average thickness (a thickness of the topcoat layer alone) of 29 μm.

### Comparative Example 2

A composite molded product was produced in the same manner as Comparative Example 1 except that the alicyclic epoxy compound B was used instead of the alicyclic epoxy compound A. The coating film had an average thickness of 26 μm.

### Comparative Example 3

A composite molded product was produced in the same manner as Comparative Example 1 except that the bisphenol A-based epoxy resin was used instead of the alicyclic epoxy compound A. The coating film had an average thickness of 32 μm.

### Comparative Example 4

An aluminum plate was degreased with acetone. As a coating composition for a topcoat layer, a composition containing 100 parts by weight of the alicyclic epoxy compound A, 0.25 parts by weight of the curing agent, and 1 part by weight of the leveling agent was provided. The coating composition was applied on the degreased aluminum plate with the use of a wire bar #20 and was then prebaked at 80° C. for one minute. The prebaked product was then ultraviolet-treated at a cumulative quantity of 400 mJ/cm² by irradiation with an ultraviolet ray using a belt-conveyor high-pressure mercury lamp (“UVC-02516S1” manufactured by USHIO INC.) at a lamp outlet of 120 W and a conveyor speed of 5.5 m/min. Finally, the UV-treated product was heat-treated (aged) at 150° C. for one hour for curing the UV-treated coating composition to give a composite molded product having the topcoat layer alone (a coated aluminum plate). The coating film had an average thickness (a thickness of the topcoat layer alone) of 37 μm.

### Comparative Example 5

A composite molded product was produced in the same manner as Example 1 except that the bisphenol A-based epoxy resin was used instead of the alicyclic epoxy compound A. The coating film had an average thickness of 38 μm.

### Comparative Example 6

An aluminum plate was degreased with acetone. The acrylic oligomer was applied on the decreased aluminum plate with the use of wire bar #3 and was then prebaked at 80° C. for one minute. The prebaked product was then ultraviolet-treated at a cumulative quantity of 200 mJ/cm² by irradiation with an ultraviolet ray using a belt-conveyor high-pressure mercury lamp (“UVC-02516S1” manufactured by USHIO INC.) at a lamp outlet of 80 W and a conveyor speed of 6.7 m/min. to give a primer layer (a first layer).

A composite molded product was produced by forming a topcoat layer on the resulting primer layer in the same manner as Example 1. The coating film had an average thickness of 38 μm.

Table 1 shows the evaluation results of the composite molded products obtained in Examples and Comparative Examples.

TABLE 1

| | Thickness | | Boiling water | Scratch test (N) | | Indentation |
|---|---|---|---|---|---|---|
| | of coating | Adhesion | resistance | Deformation | | hardness |
| | film (μm) | test | (Adhesion test) | start | Delamination | (N/mm²) |
| Example 1 | 37 | 25/25 | No delamination | 14 | 18 | 573 |
| | | | (25/25) | | | |
| Example 2 | 36 | 25/25 | No delamination | 10 | 12 | — |
| | | | (25/25) | | | |
| Example 3 | 31 | 25/25 | — | — | — | — |
| Example 4 | 36 | 25/25 | — | — | — | — |
| Example 5 | 29 | 25/25 | No delamination | 11 | 13 | — |
| | | | (25/25) | | | |
| Example 6 | 31 | 25/25 | — | 6 | 12 | 320 |
| Comparative | 29 | 0/25 | — | — | — | — |
| Example 1 | | | | | | |
| Comparative | 26 | 0/25 | — | — | — | — |
| Example 2 | | | | | | |
| Comparative | 32 | 16/25 | — | — | — | — |
| Example 3 | | | | | | |
| Comparative | 37 | 0/25 | Delamination | — | — | — |
| Example 4 | | | | | | |
| Comparative | 38 | 25/25 | — | 3 | 14 | 250 |
| Example 5 | | | | | | |
| Comparative | 38 | 25/25 | Delamination | 10 | 12 | — |
| Example 6 | | | | | | |

As apparent from Table 1, the composite molded products of Examples had a high adhesion and a high heat resistance. In contrast, the composite molded products of Comparative Examples 1 to 4 had a low adhesion, the composite molded product of Comparative Example 5 had a low indentation hardness, and the composite molded product of Comparative Example 6 had a low heat resistance.

### INDUSTRIAL APPLICABILITY

In an embodiment of the present invention, the automotive part is effectively utilizable as, for example, an engine part, e.g., a coating member of a piston skirt; a sliding part such as a cam bearing, a crank bearing, or a connection rod bearing; a shaft part such as a camshaft or a crankshaft; a valve-gear sliding member such as a roller rocker, a rocker arm, a hydraulic lash adjuster, or a valve lifter; a chain-driven sliding part such as a chain guide, a chain damper, or a chain slipper; an engine auxiliary part such as a bearing portion of a vane or trochoid oil pump or a bearing portion of an alternator; or other transmission bearing parts.

### REFERENCE SIGNS LIST

1, 1a, 1b . . . Heat-resistant layer

1. An automotive part comprising:
a substrate, and
a heat-resistant layer,
wherein the heat-resistant layer contains a first layer on a surface of the substrate and a second layer on the first layer, the first layer contains a polyamideimide resin, and the second layer contains a cured product of (A) a curable liquid composition containing an alicyclic epoxy compound represented by the formula (1): 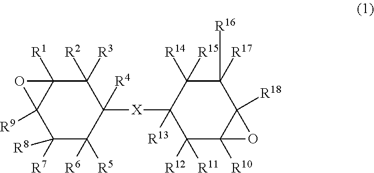
wherein R¹ to R¹⁸ are the same or different and each represent a hydrogen atom, a halogen atom, an oxo group, a hydroxyl group, a hydroperoxy group, an amino group, a sulfo group, or an organic group, and X represents a direct bond or a linkage group.

2. The automotive part according to claim 1, wherein the curable liquid composition (A) further comprises a curing agent.

3. The automotive part according to claim 1, wherein the curable liquid composition (A) further comprises a leveling agent.

4. The automotive part according to claim 1, wherein the first layer further comprises at least one solid lubricant selected from the group consisting of a fluorine compound, a metal sulfide, and a carbon material.

5. The automotive part according to claim 1, wherein at least one of R¹ to R¹⁸ in the formula (1) is a hydrogen atom, and X is a direct bond.

6. The automotive part according to claim 1, wherein the second layer has an indentation hardness of not less than 300 N/mm² measured by amicrohardness tester.

7. The automotive part according to claim 1, wherein an average thickness of the second layer is 2 to 100 times as large as that of the first layer.

8. The automotive part according to claim 1, wherein the substrate comprises a metal.

9. The automotive part according to claim 8, wherein the metal comprises aluminum or an alloy thereof.

10. A process for producing an automotive part, comprising:
applying (B) a liquid composition containing a polyamideimide resin on a surface of a substrate and solidifying the applied liquid composition (B) to form a first layer, and
applying (A) a curable liquid composition recited in claim 1 on a surface of the resulting first layer and curing the applied liquid composition (A) to form a second layer.
